(19) United States
(12) Patent Application Publication
(10) Pub. No.: US 2008/0155630 A1
(43) Pub. Date: Jun. 26, 2008

(54) DISTRIBUTOR-EMBEDDED CABLE MODEM MODULE, TV RECEIVER, SET-TOP-BOX, AND METHOD FOR CONNECTING DISTRIBUTOR-EMBEDDED MODEM MODULE TO TUNER MODULE

(75) Inventor: Masami Oosawa, Kumagaya-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/961,084

(22) Filed: Dec. 20, 2007

(30) Foreign Application Priority Data
Dec. 25, 2006 (JP) 2006-348365

(51) Int. Cl. H04N 7/173

(52) U.S. Cl. 725/111

(57) ABSTRACT

According to one embodiment, a cable modem module includes a first RF terminal connected to a CATV center station via a cable and a second RF terminal connected to an external tuner module. The second RF terminal is provided to the distributor-embedded cable modem module in such a manner that the height of the second RF terminal is identical to that of an RF input terminal of the external tuner module when the distributor-embedded cable modem module and the external tuner module are mounted to a circuit substrate, and has a structure to be directly connected to the RF input terminal.

### CROSS-REFERENCE TO RELATED APPLICATIONS

This application is based upon and claims the benefit of priority from Japanese Patent Application No. 2006-348365, filed Dec. 25, 2006, the entire contents of which are incorporated herein by reference.

### BACKGROUND

1. Field

One embodiment of the present invention relates to a distributor-embedded cable mode module (hereinafter called cable modem module) which distributes signals contained in signals received via a cable television (CATV) line to a tuner module and an information terminal such as a PC.

2. Description of the Related Art

As is well known, as an interface which connects information terminals such as a personal computer (PC) owned by a user to the network such as Internet via, for example, a CATV line, a cable modem module has been developed. This cable modem module is connected to the CATV line, receives CATV signals supplied from the CATV center station, and supplies video pictures and audio signals of each broadcasting channel to an external television tuner. In addition, the cable modem module provides an interface with the network via the CATV center station to the connected terminal such as PC. This enables the terminal to carry out bidirectional data communication with the network.

Signals (downstream signals) transmitted from the CATV center station to the cable modem module are, in general, analog signals of a band from 90 MHz to 860 MHz, etc. Of this band, the downstream channel signals for modem (for terminals) is transmitted by the use of a vacant channel of CATV, and for example, 6-MHz bandwidth is used. The downstream channel signals for modem are converted into the intermediate frequency in the cable modem module after reception, are converted into digital signals, undergo demodulation, etc., and are provided to television receivers, a set-top-box, an external PC and other terminals with a cable modem module mounted.

The data transmitted from the cable modem module to the CATV center station (upstream signals) are supplied from the terminal to the cable modem module as digital signals. The digital signals are converted to analog signals after they are modulated in the cable modem module, and sent out to the CATV center station as signals of the band from, for example, 5 to 55 MHz, etc.

In order to achieve the foregoing functions, the cable modem module has a Radio Frequency (RF) coaxial connector to connect cables from the CATV center station and a diplexer that branches signals supplied to the connector from the CATV center station and signals sent out from the connector to the CATV center.

Furthermore, the cable modem module has a distributor that divides received signals branched by the diplexer into two or more signals, a circuit to provide one output of this distributor to the television tuner, and a frequency converter that frequency-converts the other output of the distributor.

In addition, the cable modem module has a modulation-demodulation processing and interface unit. This modulation-demodulation processing and interface unit converts outputs of the frequency converter into digital signals, and then, digitally demodulates and transmits the signals to a television receiver, a set-top-box, a PC, and other external devices with the cable modem module mounted. Furthermore, the modulation-demodulation processing and interface unit receives signals from the television receiver, the set-top-box, the PC, and other external devices with the cable modem module mounted, and digitally modulates the received signals, then, analog-coverts and supplies the signals to the diplexer.

This kind of cable modem module independently becomes commercially available as a product and in addition, is combined in an apparatus such as TV and is brought to the market.

In general, the cable modem module and the tuner module are connected by the use of a coaxial cable. In the event that the cable modem module and the tuner module are used for mass-produced products and not so long cables are used, for the coaxial cable, a thin cable is frequently used with the cable flexibility taken into account and to suppress a cost increase. However, thin coaxial cables generate a larger loss than thick ones, and have large effects (noise mixture) caused by radiation of unrequited signals from the outside of the coaxial cable. It is difficult to satisfy both cost and performance. Consequently, a connection system of the cable modem module and the tuner module, which prevents signal quality degradation and which is inexpensive and has an easy configuration has been desired.

FIGS. 2, 3, and 8 of Jpn. Pat. Appln. KOKAI Publication No. 2003-101421 show configurations of a tuner module which receives distributed output signals from the cable modem module. FIG. 2 shows a distributed output method and structure of a coaxial cable equipped with an RCA phono jack, FIG. 3 a mini jack, and FIG. 8 a connector (RCA pin plug). However, no specific method of connecting the distribution output terminal of the cable modem module and the tuner is set forth therein. FIG. 8 of this document shows a tuner module equipped with a coaxial cable having provided at its head end a coaxial connector, and it is assumed that this connector is connected to the distribution output terminal of the cable modem module. Also in this case, the coaxial cable is required and a cost increase results.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a diagram showing the outline of a CATV broadcasting system;

FIG. 2 is a diagram showing a TV configuration, and, in particular, an internal circuit configuration of a cable modem module in detail;

FIG. 3 is a diagram showing the structure of the cable modem module;

FIG. 4 is a diagram showing the structure of a tuner module;

FIG. 5 is a diagram showing the state in which the cable modem module is connected to the tuner module;

FIG. 6 is a diagram showing the structure of the device in FIG. 5 as viewed from the top;

FIG. 7 is a diagram showing how the cable modem module and the tuner module are mounted to a set substrate with the cable modem module and the tuner module connected;

FIG. 8 is a diagram showing one example of a reinforcement measure applied to the cable modem module and the tuner module;

FIG. 9 is a diagram showing the detail of a junction 51 of FIG. 8;

FIG. 10 is a diagram showing the detail of a junction 52 of FIG. 8;

FIG. 11 is a diagram showing a process to assemble the cable modem module and the tuner module which have the structures of FIGS. 8 to 10;

FIG. 12 is a diagram showing an example of providing a stopper to assembly pawls, with portions corresponding to a pawl 61 and a pawl 62 of FIG. 9 only enlarged;

FIG. 13 is a diagram showing the state of the pawl 61 assembled with the pawl 62;

FIG. 14 is a diagram showing another example with a stopper provided in an assembly pawl;

FIG. 15 is a diagram showing the state of the pawl 61 assembled with the pawl 62;

FIG. 16 is a drawing that shown a configuration with an inexpensive tuner used; and

FIG. 17 is a diagram showing an example in which multiple distribution output terminals are provided on one side surface of the cable modem module.

### DETAILED DESCRIPTION

Various embodiments according to the invention will be described hereinafter. In general, according to one embodiment of the invention, there is provided a distributor-embedded cable modem module which distributes signals contained in signals received via a CATV line to an external tuner module having an RF input terminal and to an external information terminal, respectively, comprising: a first RF terminal to which a cable from a CATV center station is connected; and a second RF terminal which is connected to the external tuner module, wherein the second RF terminal is provided in the distributor-embedded cable modem module in such a manner that the height from a circuit substrate becomes identical to the height of an RF input terminal of the external tuner module when the distributor-embedded cable modem module and the external tuner module are mounted to the circuit substrate, and has a structure which is directly connected to the RF input terminal.

There is provide a cable modem module having a distribution output terminal configuration that enables connection with the tuner module, which can achieve inexpensive and simple configuration and can prevent signal quality degradation caused by radiation of unrequited signals. Referring now to the drawings, embodiments of a cable modem module according to the present invention will be described in detail as follows.

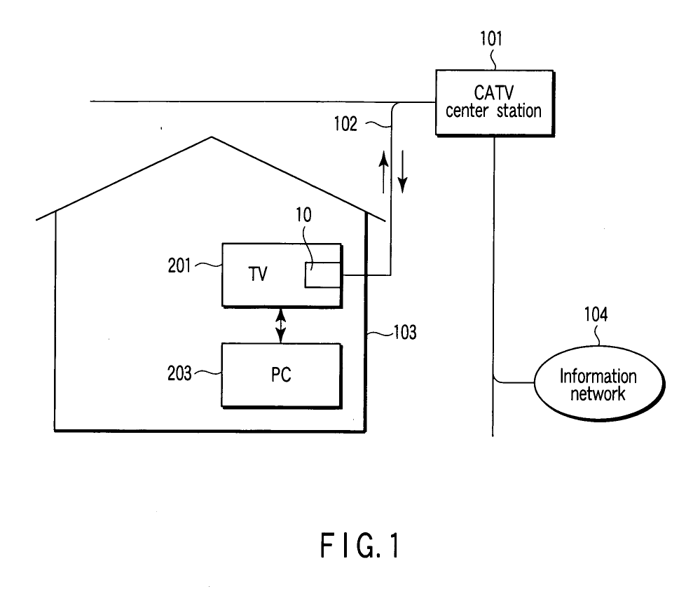

FIG. 1 shows the outline of a CATV broadcasting system. In FIG. 1, reference numeral 101 denotes a CATV center station. This CATV center station 101 is connected to a cable modem module 10 installed in each subscriber home 103 via a CATV cable 102. This cable modem module 10 is installed inside a TV (television receiver) 201. The CATV center station 101 is connected to, for example, various information networks such as Internet 104. Note that, in this embodiment, the cable modem module 10 is installed inside TV, but may be installed in a set-top-box (STB) or in a video image apparatus such as PCs with built-in TV tuners.

The cable modem module 10 has functions to perform control of communication with the CATV center station 101, generation of upstream signals to be transmitted to the CATV center station 101, demodulation of downstream signals transmitted from the CATV center station 101, and control of data communication with an external device (PC 203 in this case) connected to the cable modem module 10.

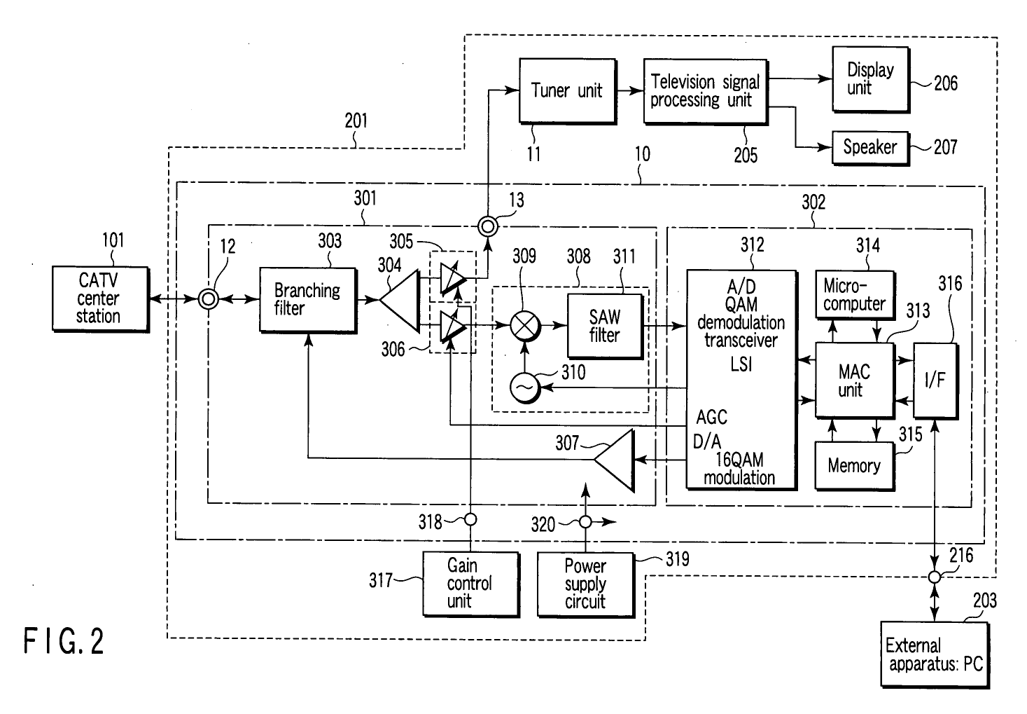

FIG. 2 is a diagram showing a configuration of the TV 201, and in particular, showing the internal circuit configuration of the cable modem module 10 in detail. This cable modem module 10 is provided in the TV 201 and includes an analog signal processing unit 301 which processes high-frequency signals transmitted and received to/from the CATV center station 101 via an RF coaxial connector 12, and a digital signal processing unit 302 which digitally processes signals inputted and outputted to/from this analog signal processing unit 301.

The analog signal processing unit 301 has a diplexer (branching filter) 303. The diplexer 303 receives signals from the CATV center station, which are supplied via the RF coaxial connector 12, and has branching functions to send out signals to the CATV center station 101 via the RF coaxial connector 12.

Furthermore, the analog signal processing unit 301 includes a distributor 304 which distributes the signals from the CATV branched by the diplexer 303 to two routes, and variable gain amplifiers 305, 306 which adjust gains of each output of the distributor 304. Furthermore, the analog signal processing unit 301 includes an RF connector 13 that provides outputs of the variable gain amplifier 305 to the outside, a frequency converter unit 308 that converts the output frequency of the variable gain amplifier 306, and an amplifier 307 that amplifies signals inputted from the digital signal processing unit 302 and provides the signals to the diplexer 303 as upstream signals.

The frequency converter unit 308 is configured by a mixer 309 to which output signals of the variable gain amplifier 306 are supplied, a local oscillator 310 which supplies signals for frequency conversion to the mixer 309, and a surface acoustic wave (SAW) filter 311 that extracts and outputs signals of a predetermined frequency band from the output signals of the mixer 309. The frequency converter unit 308 has a function of converting the RF signals to intermediate-frequency signals and outputting the converted signals.

The digital signal processing unit 302 has a transceiver large-scale integrated circuit (LSI) 312 to which signals from the SAW filter 311 are supplied. The transceiver LSI 312 has functions to perform analog to digital (A/D) conversion processing that converts signals from the SAW filter 311 to digital signals and to perform quadrature amplitude modulation (QAM) processing for the converted digital signals. Furthermore, the transceiver LSI 312 has a modulation processing function that carries out 16QAM-modulation on upstream data from a MAC unit 313 later discussed, a digital to analog (D/A) conversion processing function that converts modulated digital signals to analog signals, and a function that controls oscillation frequency of the local oscillator 310 of the frequency converter unit 308 and controls gains of the variable gain amplifier 306. The D/A-converted upstream data are supplied to the diplexer 303 via the amplifier 307.

Furthermore, the digital signal processing unit 302 has a media access control (MAC) unit 313 that receives QAM-demodulated digital signals outputted from the transceiver LSI 312. The MAC unit 313 has a function to communicate with the PC 203 as an external device. Consequently, a microcomputer 314 and memory 315 are connected to the MAC unit 313 and furthermore, an Ethernet Interface (I/F) 316 is connected thereto.

The MAC unit 313 provides downstream data to the PC 203 connected to an Ethernet terminal 216 via the I/F 316, receives the upstream data from the PC 203 via the I/F 316 and sends the data to the LSI transceiver 312. The LSI transceiver 312 carries out modulation and A/D conversion processing to the received signals and the processed signals are provided to the diplexer 303 via the amplifier 307.

The cable modem module 10 is further equipped with a terminal 318 which receives gain control signals from a gain control unit 317 installed in the TV 201 in order to control the variable gain amplifier 305, and a terminal 320, similarly installed in the TV 201, which receives operating power supply voltage from a power supply circuit 319 that supplies operating power supply to each unit of the cable modem module 10.

In FIG. 2, CATV signals from the CATV center station 101 are sent from the RF coaxial connector 12 to the distributor 304 via the diplexer 303 and divided into two signal routes at the distributor 304, and one signal is supplied to the tuner module 11 via the variable gain amplifier 305 and the RF connector 13.

The other output signal of the distributor 304 is supplied to the frequency converter unit 308 via the variable gain amplifier 306. At the frequency converter unit 308, the oscillation frequency of the local oscillator 310 is controlled under the control of the transceiver LSI 312, and signals of a predetermined frequency band are provided from the mixer 309 via the SAW filter 311. In this way, the frequency converter unit 308 has a function as a so-called channel-selection device. That is, the transceiver LSI 312 controls the local oscillator 310, which in turn supplies local oscillation frequency signals to the mixer 309. This local oscillation frequency signal has the frequency that corresponds to a channel of QAM-modulated downstream signals which exist in output signals of the SAW filter 311.

The downstream signals from the SAW filter 311 are processed at the digital signal processing unit 302 and are provided to the PC 203. The upstream signals from the PC are supplied from the digital signal processing unit 302 to the diplexer 303 via the amplifier 307 and transmitted to the CATV center station 101 via the RF coaxial connector 12.

At the tuner module 11, a desired channel is selected, and broadcasting signals of the selected channel are demodulated into video image signals and audio signals by a television signal processing unit 205. The video image signals and audio signals demodulated by the signal processing unit 205 are outputted to a display unit 206 and a speaker 207 via a filter and an amplifier (not illustrated), respectively, and submitted to user's viewing and listening.

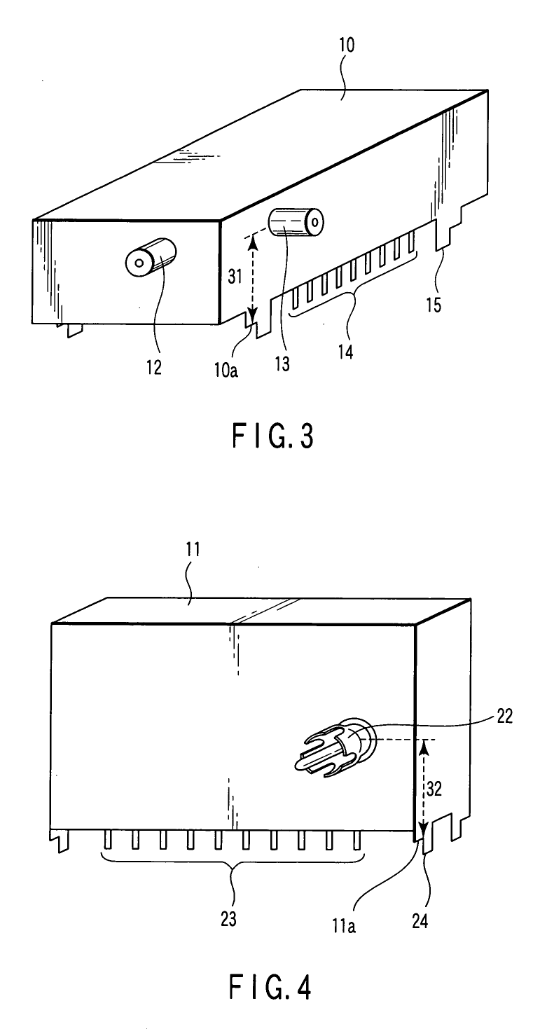

FIG. 3 is a diagram showing a structure of the cable modem module. The cable modem module 10 has an RF coaxial connector 12 which is connected to the coaxial cable and delivers upstream and downstream RF signals. For the RF coaxial connector 12, a jack type is used in this example. The cable modem module 10 has a distributor embedded therein as described above, and its RF-side output signals are outputted from a distribution output terminal (RF coaxial connector) 13. For the distribution output terminal 13, a jack type is used in this example. In the cable modem module 10, a mounting leg 15 that enables mounting to the set substrate (circuit substrate) and a terminal group 14 which delivers power supply, data signals, control signals, and other signals to the set substrate are equipped.

FIG. 4 is a diagram showing a structure of a tuner module 11. The tuner module 11 is equipped with an RF input terminal 22 directly connectable to the distribution output terminal 13 of the cable modem module 10. For the RF input terminal 22, a plug type is used in the present example. In the tuner module 11, a mounting leg 24 that enables mounting to the set substrate and a terminal group 23 which delivers power supply, data signals, control signals, and other signals to the set substrate are equipped.

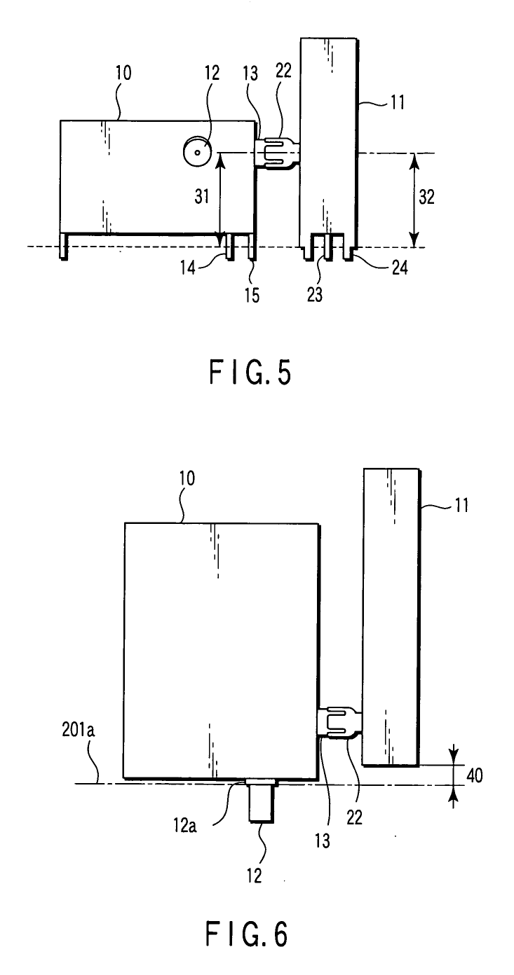

FIG. 5 is a diagram showing a state in which the cable modem module 10 and the tuner module 11 are connected. The distribution output terminal 13 is of a jack type, to which the corresponding RF input terminal 22 of a plug type is directly connected. In such event, with mounting to the set substrate taken into account, the height 31 from the mounting leg 15 to the distribution output terminal 13 is identical to the height 32 from the mounting leg 24 to the RF input terminal 22. The height 31 is the height from a set-substrate contact position 10a to the center of the distribution output terminal 13 as shown in FIG. 3, and the height 32 is the height from a set-substrate contact position 11a to the center of the RF input terminal 22 as shown in FIG. 4.

FIG. 6 is a diagram showing a structure of the device of FIG. 5 as viewed from the top. In general, the RF coaxial connector 12 protrudes from a housing of the TV or set-top box which incorporates the cable modem module 10 and is connected to the coaxial cable. Consequently, in the state with the cable modem module 10 connected to the tuner module 11, the tuner module 11 should be offset from a surface 201a assumed to be the housing surface of the TV or set-top box towards inside the housing by a predetermined distance 40. This predetermined distance 40 is a distance of 0 mm or more. Note that, between the housing surface and the housing surface-side end face of the cable modem module 10, a clearance is generated by the thickness of a spacer 12a of the RF coaxial connector 12.

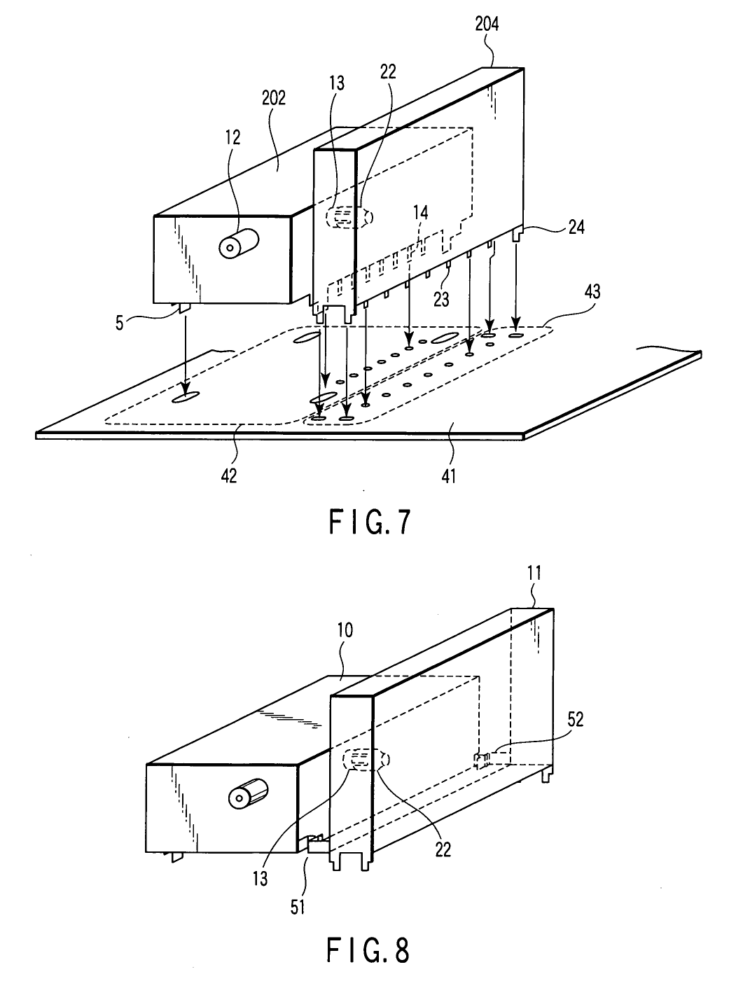

FIG. 7 is a diagram showing how the cable modem module 10 and the tuner module 11 are mounted to a set substrate 41 with the cable modem module 10 and the tuner module 11 connected. The set substrate 41 has an insertion hole group 42 for inserting a mounting leg 15 and the terminal group 14 for the cable modem module 10, and an insertion hole group 43 for inserting a mounting leg 24 and the terminal group 23 for the tuner module 11 so that the insertion to the set substrate 41 is enabled with the cable modem module 10 and the tuner module 11 connected.

Next discussion will be made on the method of connecting the cable modem module and the tuner module.

When the cable modem module 10 and the tuner module 11 are connected, only directly connecting the distribution output terminal 13 to the RF input terminal 22 may result in poor dimensional accuracy or low structural strength. In such event, mounting to the set substrate becomes difficult with the cable modem module 10 connected to the tuner module 11. FIG. 8 shows one example of a reinforcing measure (fixing means) applied to the cable modem module 10 and the tuner module 11.

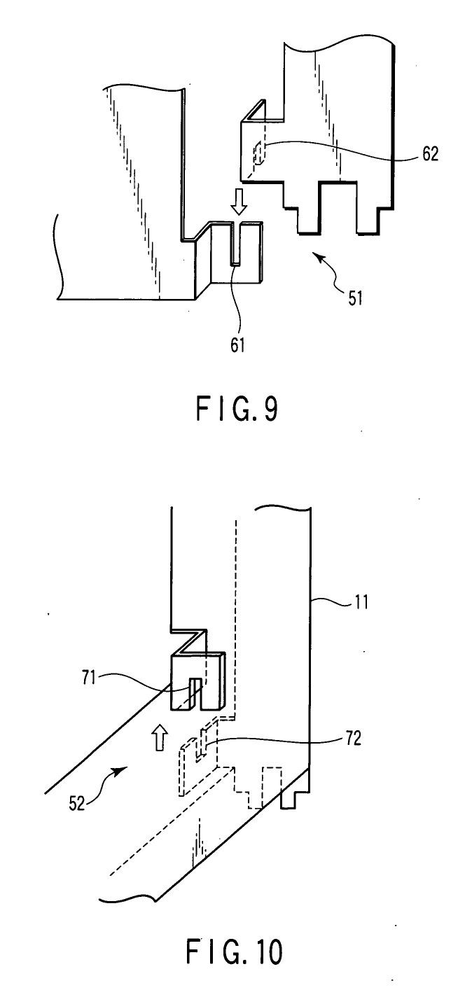

Junctions 51, 52 of the cable modem module 10 and the tuner module 11 have structures to mutually combine the junctions. FIG. 9 shows the detail of the junction 51 and FIG. 10 the detail of the junction 52. An combining pawl 61 on the cable modem module 10 side of FIG. 9 is recessed downwards and an combining pawl 62 of the tuner module 11 is recessed upwards. An combining pawl 71 on the cable modem module 10 side of FIG. 10 is recessed upwards and an combining pawl 72 of the tuner module 11 is recessed downwards.

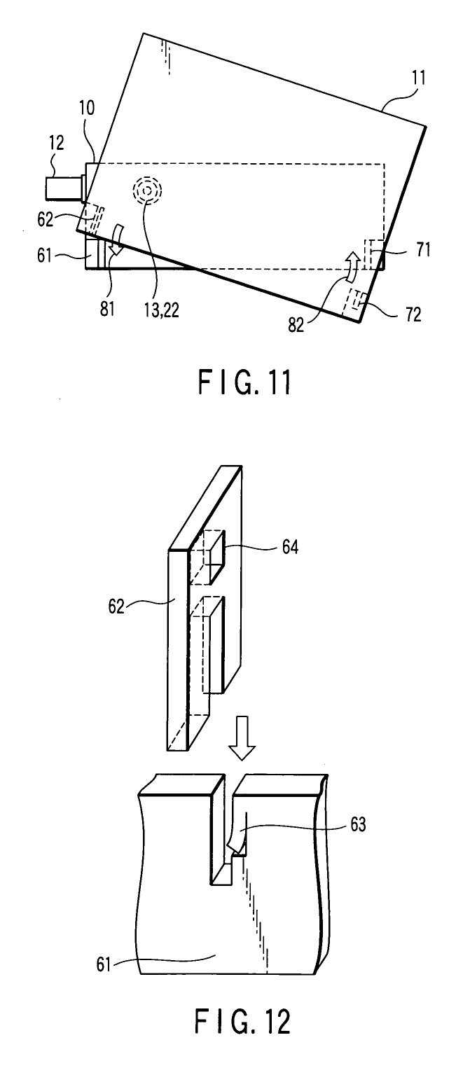

FIG. 11 shows a process to combine the cable modem module 10 with the tuner module 11, which have the structures of FIGS. 8 to 10. First of all, the distribution output terminal 13 and the RF input terminal 22 are connected with an angle provided to both the cable modem module 10 and the tuner module 11 in such a manner that the combining pawls 61, 62, 71 and 72 do not interfere with one another. Thereafter, the cable modem module 10 and the tuner module 11 are rotated in the directions of arrow marks 81, 82 to combine the combining pawls 61 and 62 and the combining pawls 71 and 72. This combines (connects) the cable modem module 10 with the tuner module 11 at 3 places of the distribution output terminal 13 and the RF input terminal 22, the combining pawls 61 and 62, and the combining pawls 71 and 72. Consequently, the cable modem module 10 and the tuner module 11 which are connected to each other achieves high dimensional accuracy and high structural strength. As a result, the cable modem module 10 and the tuner module 11 can be easily mounted to the set substrate with the cable modem module 10 and the tuner module 11 combined with each other in this way.

The combining pawls 61, 62, 71, and 72 may have the strength increased by soldering, by adding stoppers to prevent the combined pawls from being loosened, or by increasing the places of installing the combining pawls as required. In addition, as long as it is a method to securely position the pawls, it is not limited to the use of combining type pawls but welding, adhesives, or soldering only may be allowed.

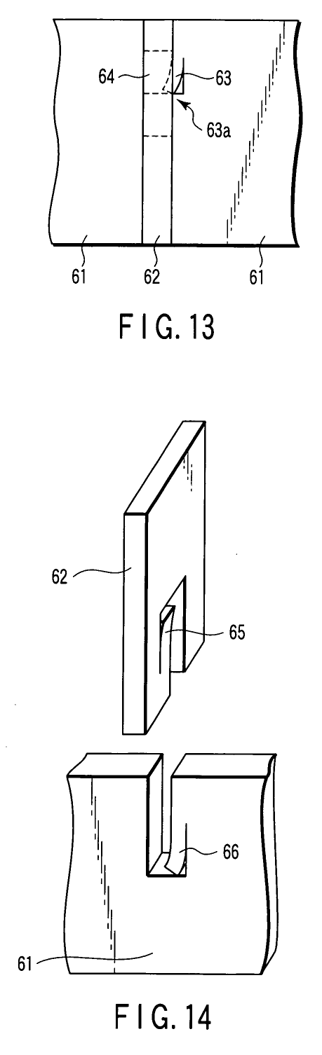

FIG. 12 shows an example with a stopper provided to the combining pawl, and is an enlarged view of the portions that correspond to the pawl 61 and the pawl 62 of FIG. 9. A protrusion 63 is formed by performing a cutout process to the recessed portion of the pawl 61. A square hole 64 is a hole for the pawl 62 to receive the protrusion 63 when the pawl 62 is assembled into the pawl 61. FIG. 13 shows the state with the pawl 62 assembled into the pawl 61. Because the protrusion 63 engages with the square hole 64, the pawl 61 and the pawl 62 do not come off.

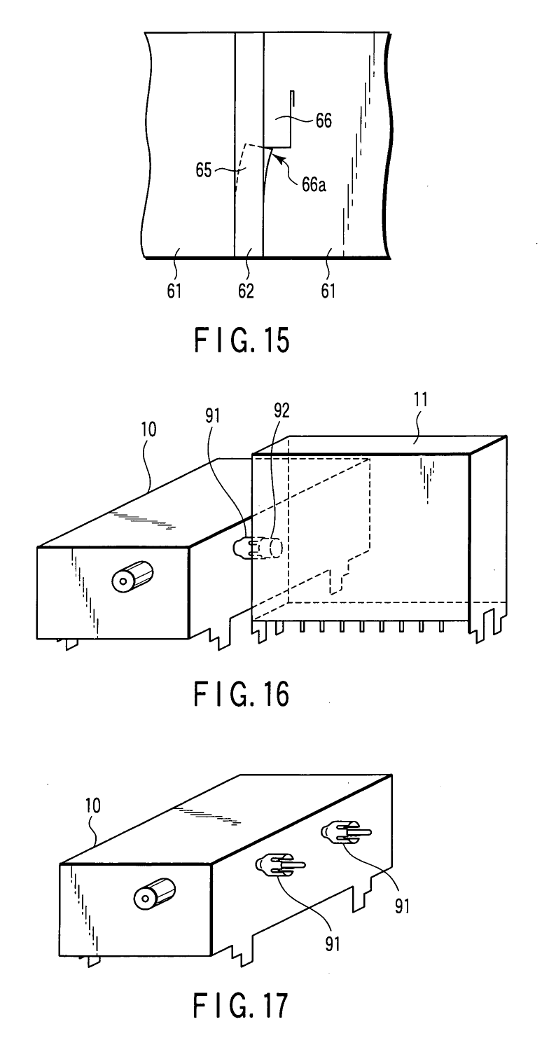

FIG. 14 shows another example with a stopper provided to the combining pawl, and like FIG. 13, shows the portion corresponding to the pawl 61 and the pawl 62 of FIG. 9 only enlarged. A protrusion 66 is formed in the recessed portion of the pawl 61 by performing cut-out processing to the near side of the figure. A protrusion 65 is formed in the recessed portion of the pawl 62 by performing cut-out processing to the right side of the figure. FIG. 15 shows the state with the pawl 62 assembled in the pawl 61. Because the head end of the protrusion 66 and the head end of the protrusion 65 engage with each other, the pawl 61 and the pawl 62 are not easily disengaged.

In the above-mentioned embodiment, the distribution output terminal 13 is of a jack type and the RF input terminal 22 is of a plug type, but these may be inverted. In general, in the case of an inexpensive tuner, a jack type is most frequently used for the RF input terminal. In addition, in the case of a general tuner, the RF input terminal is not equipped on the surface with the RF input terminal 22 equipped as shown in FIG. 4 (side surface of the wider area) but equipped on the side surface of the narrower area. The configuration as shown in FIG. 16 enables the use of this kind of inexpensive tuner.

In FIG. 16, the tuner module 11 is equipped with a jack type RF input terminal 92. This assumes a general inexpensive tuner described above. In such event, for a distribution output terminal 91 of the cable modem module 10, a plug type connector that can be combined with the RF input terminal 92 is used. In addition, it is desirable to adjust the height from the set substrate surface to the distribution output terminal 91 to the height from the set substrate surface of the tuner module 11 to the RF input terminal 92. By this configuration, a general (inexpensive) tuner with no dedicated structure design provided can be used as the tuner module 11.

FIG. 17 shows an example with a plurality of distribution output terminals 91 provided on one side surface of the cable modem module 10. By this configuration, a plurality of tuner modules 11 can be connected to the cable modem module 10, making it possible to, for example, record a counterprogram while viewing a certain program.

According to the embodiment of the invention, as described in FIGS. 3 to 7, no coaxial cable is required by directly connecting the distribution output terminal 13 of the cable modem module 10 to the RF input terminal 22 of the tuner module 11. As a result, it is possible to cut the cost of the coaxial cable. In addition, there is no loss when RF signals pass the coaxial cable, there is no unrequired signal which is radiated to the coaxial cable and superimposed on the RF signals, and noise performance, etc. are improved, thereby providing high-quality signals to the tuner module 11.

Furthermore, as described in FIGS. 8 to 16, by providing combining pawls to the cable modem module 10 and the tuner module 11 and combining these pawls mutually to connect the modules, the overall dimensional accuracy and structural strength of the cable modem module 10 and the tuner module 11 connected to each other can be improved.

In addition, by adopting a plug type as shown in FIG. 16 for the structure of the cable modem module 10 and the distribution output terminal equipped to the module, a general and inexpensive tuner can be used and the cost can be reduced.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A distributor-embedded cable modem module which distributes signals contained in signals received via a CATV line to an external tuner module having an RF input terminal and to an external information terminal, respectively, comprising:
a first RF terminal to which a cable from a CATV center station is connected; and
a second RF terminal which is connected to the external tuner module,
wherein the second RF terminal is provided in the distributor-embedded cable modem module in such a manner that the height from a circuit substrate becomes identical to the height of an RF input terminal of the external tuner module when the distributor-embedded cable modem module and the external tuner module are mounted to the circuit substrate, and has a structure which is directly connected to the RF input terminal.

2. The distributor-embedded cable modem module according to claim 1, wherein fixing units to fix the distributor-embedded cable modem module and the tuner module are mounted to a side surface on which the second RF terminal is provided.

3. The distributor-embedded cable modem module according to claim 2, wherein the fixing units are configured by a first pawl with a notch unit at the bottom side of the first pawl that receives a first fixing unit provided on the tuner module and a second pawl with a notch unit at the top side of the second pawl that receives a second fixing unit provided on the tuner module.

4. The distributor-embedded cable modem module according to claim 1, wherein the second RF terminal is a plug-type RF connector.

5. The distributor-embedded cable modem module according to claim 1, wherein a plurality of second RF terminals are provided on the same side surface of the distributor-embedded cable modem module.

6. The distributor-embedded cable modem module according to claim 1, wherein the second RF terminal is a plug type RF connector, and a plurality of them are provided on the same side surface of the distributor-embedded cable modem module.

7. A television receiver, comprising:
a tuner module which has an RF input terminal and carries out channel-selection processing on RF signals inputted from the RF input terminal;
a distributor-embedded cable modem module which has a first RF terminal to which a cable from a CATV center station is connected and a second RF terminal which is connected to the tuner module, and distributes signals contained in the signals received by the first RF terminal to the tuner module and an external information terminal, respectively;
a television signal processing circuit which demodulates signals provided from the tuner module and provides video signals; and
a display unit which displays video image in accordance with the video signals provided from the television signal processing circuit,
wherein the distributor-embedded cable modem module and the tuner module are mounted onto the same circuit substrate, and the second RF terminal of the distributor-embedded cable modem module is directly connected to the RF input terminal of the tuner module.

8. The television receiver according to claim 7, wherein the second RF terminal is a plug-type RF connector, and a plurality of them are provided on the same side surface of the distributor-embedded cable modem module.

9. A method for connecting a distributor-embedded cable modem module to a tuner module having an RF input terminal,
wherein the distributor-embedded cable modem module comprises a first RF terminal to which a cable from a CATV center station is connected and a second RF terminal to be connected to the tuner module,
the second RF terminal is provided to the distributor-embedded cable modem module in such a manner that the height of the second RF terminal from a circuit substrate becomes identical to the height of the RF input terminal of the external tuner module from the circuit substrate when the distributor-embedded cable modem module and the external tuner module are mounted to the circuit substrate, and
the second RF terminal is directly connected to the RF input terminal and the distributor-embedded cable modem module and the external tuner module are mounted to the circuit substrate.
